(19) United States
(12) Patent Application Publication
(10) Pub. No.: US 2004/0204978 A1
(43) Pub. Date: Oct. 14, 2004

(54) Method and device or arrangement for the management of a resource schedule

(75) Inventor: Martin Rayrole, Chatillon (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/764,526

(22) Filed: Jan. 27, 2004

(30) Foreign Application Priority Data
Jan. 28, 2003 (FR) 03 00 895

(51) Int. Cl. G06F 17/60

(52) U.S. Cl. 705/8

(57) ABSTRACT

A method is dedicated to the management of a resource schedule presenting a chosen time granularity and covering a chosen overall period, each resource being capable of being divided into resource fractions each associated with a reservation period defined at least by an initial instant. This method consists, firstly, of storing the schedule in the form of a so-called “n-ary” tree, that is a tree of order n, where n is two or more, equipped with leaves (Nj4), each representing a time interval (Tj) equal to the chosen granularity, and of branches growing from nodes (Nji) each corresponding to a secondary period equal to the sum of the time intervals (Tj) represented by all of the leaves which are associated with it, and secondly, storing in each node (Nji) known as a primary node because it belongs to a set of a minimum number of nodes jointly representing a reservation period, the data representing the maximum reserved resource quantity in the corresponding secondary period.

The invention concerns the field of resource management, and more particularly the management of a resource schedule.

The word “resource” should be interpreted here in its widest sense. In fact, the invention concerns any type of resource, be it the resources of a reservation network, such as hire cars for example, or indeed the resources of a communication network, such as its passband for example, or the number of connections, or the computing load.

In the non-exhaustive case of a communication network, it is common to employ network management systems, or NMS for short, in order to manage the allocation of resources in accordance with reservation requests. Some of these applications specify schedules for storing data which are representative of the availability of the network resources as a function of the date and the time.

However, because of their storage architectures and the very high volume of data not only to be stored but especially to be managed, these schedules are suitable only for the reservation of resources which are either of short duration associated with a fine granularity, or of long duration associated with a coarse granularity. Here, “granularity” means the smallest resource reservation time interval within a schedule.

The current situation is therefore not satisfactory in view of the ever-increasing requirements in the field of resource reservation, especially in communication networks.

The aim of the invention is therefore to improve the current situation.

To this end, it proposes a method for the management of a resource schedule presenting a chosen time granularity granularity (chosen in accordance with the need) and covering a chosen overall period (also in accordance with the need), each resource being capable of being divided into resource portions (or fractions), each associated with a reservation period defined at least by an initial instant.

This process is characterised by the fact that it includes:

a) storing the schedule in the form of a tree, known as an “n-ary tree”, meaning that it is of order n, where n is two or more, accompanied by “leaves”, each representing a time interval equal to the chosen granularity, and of “branches” growing from “nodes” each corresponding to a secondary period equal to the sum of the time intervals represented by all of the leaves which are associated with it, and

b) storing at each node, known as a primary node because it belongs to a set of a minimum number of nodes jointly representing a reservation period, the data representing the maximum resource quantity reserved in the corresponding secondary period.

By “tree of order n” is meant here, a binary, tertiary, quaternary, or, more generally, n-ary tree, that is to say that from each node there grow n branches toward n nodes (or n terminal leaves) at a lower level. Thus, in a binary tree, two (2) branches grow from each node toward two nodes (or two leaves at a lower level.

Avantageously, in the event of a request for deletion of a resource reservation, the stored data (representing the quantities of resource reserved) can be updated. In addition, a mechanism is used to shift the schedule in time, with the passage of time.

The invention also concerns a device or arrangement for management of a resource schedule including:

firstly, a memory capable of storing the schedule in the form of an n-ary tree, of order n, where n is two or more, equipped with leaves, each representing a time interval equal to the granularity of the schedule, and of branches growing from nodes each corresponding to a secondary period equal to the sum of the time intervals represented by all of the leaves which are associated with it, and

secondly, the processing means responsible for determining, for each primary node (belonging to a set of a minimum number of nodes jointly representing a reservation period), the data representing the maximum resource quantity reserved in the corresponding secondary period, and for sending these data to the memory so that they can be stored within the n-ary tree.

Preferentially, the processing means are arranged in such a manner as to deliver, on request, the data representing the availability of a resource over a chosen period, from the data of the n-ary tree stored in the memory.

In addition, in the event of receipt of a request for deletion of a resource reservation, the processing means are preferentially arranged in such a manner as to update the data representing the quantities of resource reserved, stored in the memory.

Moreover, the processing means are preferentially arranged in such a manner as to update the memory, periodically for example, with the passage of time.

The invention also concerns a network management terminal including at least a device or arrangement of the type presented above.

The invention is particularly well suited to the management of a resource schedule in a communication network, in particular when its resources are of the cumulative type, such as the passband, the number of connections, and the computing load, for example.

Other characteristics and advantages of the invention will appear on perusal of the detailed description below, and of the appended drawings, in which:

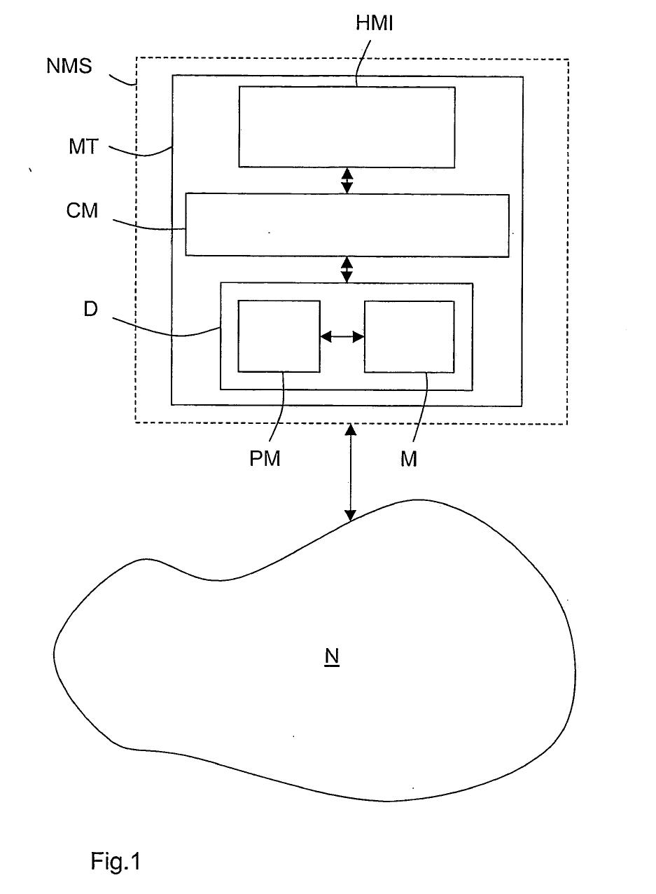

FIG. 1 schematically illustrates an example of the creation of a device or arrangement according to the invention, installed in a communication network management terminal,

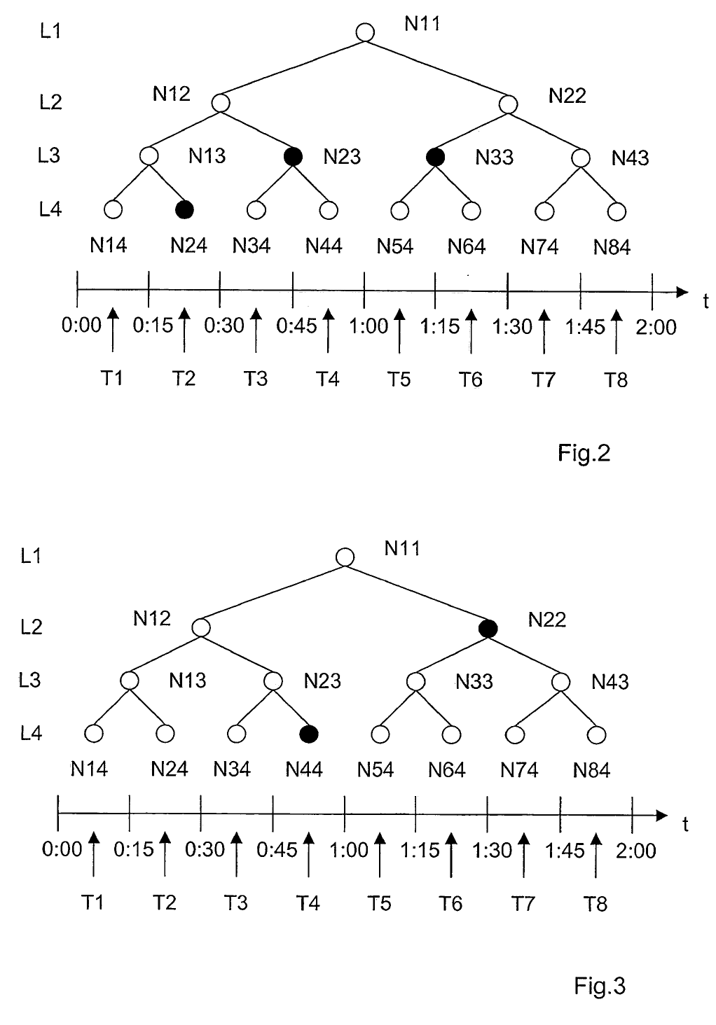

FIG. 2 schematically illustrates a schedule arranged in the form of a binary tree in which the nodes in black represent memory zones in which are stored the data representing the resource quantity reserved in a period defined by a first interval [T2-T6], and

FIG. 3 schematically illustrates a schedule arranged in the form of a binary tree in which the nodes in black represent memory zones in which are stored the data representing the resource quantity reserved in a period defined by a second interval [T4-T8].

The appended drawings can not only serve to complete the invention, but also contribute to its specification, where appropriate.

The invention concerns the management of a resource schedule, irrespective of the type. However, in what follows, as an illustration, it is considered that the resources are those of a radiocommunication network, such as a network of the GSM/GPRS or UMTS type for example. But, of course, the resources could belong to other types of networks, such as reservation networks for example, and transmission or transportation networks in particular.

As illustrated in FIG. 1, a radio network N, of the UMTS type for example, generally includes a network management system (NMS), implemented here in the form of a management terminal (MT). Such a management terminal (MT) of a network management system (NMS) includes, in particular, a control module (CM) responsible, in particular, for managing the allocation of the resources of the network (N) in accordance with reservation requests. In reality, the network management system (NMS) is responsible for numerous other network management functions which do not concern the invention directly, and which, because of this, need not be described here.

The control module (CM) can be controlled and programmed by a network manager via a man-machine interface (HMI), of the Graphical User Interface (GUI) type for example.

In order to allow the management of a resource schedule for the network (N), the invention proposes a device or arrangement (D) for schedule management which, in the illustrated example, is directly coupled to the control module (CM) of the network management system (NMS), but which could form part of said module, or indeed could be installed in dedicated equipment connected to said network management system (NMS).

This device or arrangement (D) includes firstly a memory (M) in which data specifying a resource reservation schedule is stored, presenting a chosen time granularity, covering a chosen time period (PT), and arranged in the form of a tree of the “n-ary” type, of order n, where n is two or more.

A resource reservation is always associated with a reservation period which includes at least a start instant (the date and the time for example) as well as a finish instant where appropriate (if the period is not infinite).

A tree of the n-ary type (of order n), is a tree which includes nodes (Nji) belonging to levels (Li) and from which grow n branches toward n nodes (or n terminal leaves) at a lower level. For example, in a binary tree (n=2), two branches grow from each node (Nji) of a level (Li) toward two nodes N(2j−1) (i+1) and N(2j) (i+1) (or two leaves) at the lower level L(i+1).

As illustrated in FIGS. 2 and 3, in what follows it is considered that the tree of the schedule is of the binary type (n=2). But, of course the tree can be of an order n other than two (2) whenever n is strictly greater than one (1). Then it can be of a ternary (n=3) or quaternary (n=4) tree for example.

It is also important to note that an n-ary tree is not necessarily completely balanced. In fact, it can be truncated at the level of at least one of its two ends, left or right.

Moreover, in what follows, it is considered that the schedule concerns only one resource, such as the passband of the network or the number of connections, or indeed the computing load, for example. But, of course, it could just as well be several (at least two).

In a manner of speaking, a leaf is also a node (Nji) placed at the lowest level (the highest value of i), and from which no branch grows. According to the invention, each leaf represents a time interval (Tj) equal to the granularity of the schedule, which can therefore be chosen to be as small or as large as desired, in accordance with the need.

In the example illustrated in FIGS. 2 and 3, the tree of the schedule contains i=4 levels (Li). As a result, here the leaves are nodes Nj4 (N14 to N84) of level L4, which are respectively associated with the intervals of time (atomic) T1 to T8, each representing a granularity of fifteen (15) minutes.

In addition, according to the invention, each node (Nji) corresponds to a secondary period (ST) equal to the sum of the time intervals represented by all of the leaves, which are associated with. Thus in the illustrated example, at level L3, node N13 corresponds to the secondary period (ST) equal to T1+T2; node N23 corresponds to the secondary period (ST) equal to T3+T4; node N33 corresponds to the secondary period (ST) equal to T5+T6; and node N43 corresponds to the secondary period (ST) equal to T7+T8. Likewise, at level L2, node N12 corresponds to the secondary period (ST) equal to T1+T2+T3+T4, and node N22 corresponds to the secondary period (ST) equal to T5+T6+T7+T8. Finally, at level L1, the single node N11 corresponds to the secondary period (ST) equal to T1+T2+T3+T4+T5+T6+T7+T8, which is equal to the time period (PT) of the schedule.

Device or arrangement (D) also includes a processing module (PM), coupled to the memory (M) and responsible, firstly, for determining, for each node (Nji) known as a primary node, the data representing the maximum resource quantity reserved in the corresponding secondary period (ST), and secondly, for sending the data thus determined to the memory (M) in order that they should be stored within the n-ary tree.

By definition, a node is known as a primary node if it belongs to a set of a minimum number of nodes jointly representing a reservation period. In other words, a node is known as primary for a given reservation if it satisfies the following two conditions: i) all the leaves which depend on it represent time intervals (Tj) included in the period of the reservation, and ii) it concerns the “root” node of the first level (L1) or indeed at least one leaf associated with the node of the next level above its own representing a time interval (Tj) which is not included in the period of the reservation.

For example, in the tree illustrated in FIG. 2, the black nodes (N24, N23 and N33) together represent the reservation period defined by the interval [T2, T6] (or in other words the time interval between 0 H 15 and 1 H 30). Likewise, in the tree illustrated in FIG. 3, the black nodes (N44 and N22) together represent the reservation period defined by the interval [T4, T8] (or in other words the time interval between 0 h 45 and 2 h 00.)

The maximum resource quantity reserved, associated with a primary node (and stored in the memory (M) in the form of a single data item or a data set), is defined by the sum between, firstly, the largest resource quantity reserved from among the quantities associated with its “sub-nodes” at the level immediately below, and secondly, the sum of the quantities of resource reserved in each of the reservations for which said node is a primary node. A node is said to be a sub-node of another node at a given level (Li) when it belongs to a level below said level (Li). When a primary node has no “sub-nodes”, then the maximum reserved resource quantity associated with it is the sum of the quantities of resource reserved in each of the reservations for which said node is a primary node.

Thus, when the processing module (PM) receives a request for a new resource reservation from the network management system (NMS), it only has to re-calculate the data associated with the primary nodes of the set representing the period of this new reservation, and then to re-transmit it to the memory (M), so that they are updated. This simplifies the calculations significantly.

The processing module (PM) can also deliver, on a request (from the network management system (NMS)), the data representing the availability of a resource over a chosen period. To do this, It only has to determine the set of primary nodes associated with this period, and then to access the data of the n-ary tree, stored in the memory (M), in order to extract the corresponding quantities from it.

The processing module (PM) can also delete a resource reservation on a request (from the network management system (NMS)). It then only has to re-calculate the data associated with the primary nodes of the set representing the period of the reservation to be deleted, and then to re-transmit the data to the memory (M), so that they are updated.

Moreover, the processing module (PM) is preferentially configured to update the memory (M), periodically for example, with the passage of time. To do this, it must re-calculate the data associated with the primary nodes which were associated with the leaf that has to be deleted, and then, where appropriate, to re-arrange the schedule if primary nodes have to be deleted or added, and finally to transmit the new data to the memory (M).

This update, used to shift the schedule in time, with the passage of time, is preferentially performed when there is not much modification of the resource reservations, during the night for example.

In a binary tree (n=2), the number of primary nodes belonging to a set, associated with a given reservation, is less than or equal to 2. log₂(m), where m is the number of time intervals (Tj) constituting the time period (PT) of the schedule. Generally speaking, in an n-ary tree, the number of primary nodes belonging to a set, associated with a given reservation, is less than or equal to 2. logₙ(m).

In addition, in the case of a binary tree, firstly, verification of the availability of a resource, or the addition of a new reservation, or indeed the deletion of a reservation, requires a time which is proportional to log m, and secondly, updating the schedule, when a time interval (Tj) has elapsed, requires a time which is proportional to R. log m (where R is the number of active reservations).

As a result of the invention, since the number of reservation data to be stored in the schedule-tree are significantly reduced, it is therefore possible to create schedules with a long time period (PT) and with fine granularity. As an example, a schedule-tree, intended for managing the passband of a communication network, and presenting an overall period of one year and a granularity of 5 minutes, occupies a memory space about 2.5 megabytes.

The invention also provides a method for the management of a resource schedule having a chosen time granularity and covering a chosen overall period, each resource being capable of being divided into resource fractions, each associated with a reservation period defined at least by an initial instant.

This can be implemented with the aid of a device or arrangement (D) of the type presented above. Since the main and optional functions and sub-functions provided by the steps of this method are virtually identical to those provided by the different resources constituting device or arrangement (D), the only aspects summarised below will be the steps implementing the main functions of the method in accordance with the invention.

This method consists of:

a) storing the schedule in the form of a so-called “n-ary” tree”, meaning a tree of order n, where n is two or more, equipped with “leaves”, each representing a time interval equal to the chosen granularity, and of “branches” growing from “nodes”, each corresponding to a secondary period equal to the sum of the time intervals represented by all of the leaves which are associated with it, and

b) to store, in each node known as a primary node because it belongs to a set of a minimum number of nodes jointly representing a reservation period, the data representing the maximum reserved resource quantity in the corresponding secondary period.

The invention is not limited regarding the embodiments of the methods, the device or arrangement, and of the network management terminal (MT) described above, to mention an example, but in fact covers all the variants which might be envisaged by a professional in the field, in the context of the claims below.

1. A method for the management of a resource schedule with a chosen time granularity and covering a chosen overall period (PT), each resource being capable of being divided into resource fractions, each associated with a reservation period defined at least by an initial instant, characterised in that it comprises the steps of:
a) storing said schedule in the form of a tree known as an “n-ary” tree, of order n, where n is two or more, equipped with leaves (Nj4), each representing a time interval (Tj) equal to said granularity, and with branches growing from nodes (Nji) each corresponding to a secondary period (ST) equal to the sum of the time intervals (Tj) represented by all of the leaves that are associated with it, and
b) storing in each node (Nji) known as a primary node, belonging to a set of a minimum number of nodes jointly representing a reservation period, the data representing the maximum reserved resource quantity in the corresponding secondary period (ST).

2. A method according to claim 1, characterised in that said tree is of the binary type (n=2).

3. A method according to claim 1, characterised in that in the event of a request for deletion of a resource reservation, said stored data, representing the quantities of resource reserved, are updated.

4. A method according to claim 1, characterised in that said stored data are updated with the passage of time.

5. A method according to claim 4, characterised in that said update is performed periodically.

6. A device or arrangement (D) for the management of a resource schedule with a chosen time granularity and covering a chosen overall period (PT), each resource being capable of being divided into resource fractions, each associated with a reservation period defined at least by an initial instant, characterised in that it includes:
a) a memory (M) suitable for storing said schedule in the form of so-call “n-ary” tree, of order n, where n is two or more, equipped with leaves (Nj4), each representing a time interval (Tj) equal to said granularity, and of branches growing from nodes (Nji) each corresponding to a secondary period (ST) equal to the sum of the time intervals (Tj) represented by all of the leaves that are associated with it, and
b) the processing means (PM) arranged to determine, for each node (Nji) known as primary, belonging to a set of a minimum number of nodes jointly representing a reservation period, the data representing the maximum reserved resource quantity in the corresponding secondary period (ST), and to send said data to said memory (M) so that they are stored within said n-ary tree.

7. A device or arrangement according to claim 6, characterised in that said tree is of the binary type (n=2).

8. A device or arrangement according to claim 6, characterised in that said processing means (PM) are arranged in such a manner as to deliver the data representing the availability of a resource over a chosen period.

9. A device or arrangement according to claim 6, characterised in that, in the event of a request for deletion of a resource reservation, said processing means (PM) are arranged so as to update said data representing the quantities of resource reserved, stored in said memory (M).

10. A device or arrangement according to claim 6, characterised in that said processing means (PM) are arranged so as to update said memory (M) with the passage of time.

11. A device or arrangement according to claim 10, characterised in that said processing means (PM) are arranged to update said memory (M) periodically.

12. A management terminal (MT) for a network management system (NMS), characterised in that it includes a device or arrangement (D) according to claim 6.
